(19) United States
(12) Patent Application Publication
(10) Pub. No.: US 2017/0275008 A1
(43) Pub. Date: Sep. 28, 2017

(54) TIME DELAY DEVICE FOR PARACHUTE DEPLOYMENT

(71) Applicant: The Skylife Company, Inc., Rossford, OH (US)

(72) Inventors: Jeffery J. Potter, Toledo, OH (US); Terry C. Potter, Lambertville, MI (US); Anthony J. Kujawa, Waterville, OH (US)

(21) Appl. No.: 15/467,666

(22) Filed: Mar. 23, 2017

Related U.S. Application Data
(60) Provisional application No. 62/313,286, filed on Mar. 25, 2016.
(60) Provisional application No. 62/382,451, filed on Sep. 1, 2016.

(51) Int. Cl. B64D 17/58

(52) U.S. Cl. CPC B64D 17/58

(57) ABSTRACT

Methods, devices, and systems for deploying cargo for high altitude, low opening (HALO) deployments are disclosed. The method comprises the steps of coupling a parachute deployment device to the cargo, adjusting the valve to determine rate of motion of the piston through the housing and the timing of deployment of a stored parachute, coupling the stored parachute to the parachute deployment device, coupling a drogue parachute to the parachute deployment device, and deploying the cargo from a vehicle at altitude. Upon deployment, the drogue parachute deploys and activates the parachute deployment system by pulling the piston through the housing until a release is freed from the parachute deployment system and the parachute is deployed. The parachute deployment device comprises a housing containing a fluid, a piston adapted to move within the fluid contained in the housing, and an adjustable valve coupled to the piston accessible from outside the housing.

### REFERENCE TO RELATED APPLICATIONS

This application claims priority to U.S. Provisional Application Ser. Nos. 62/313,286, filed Mar. 25, 2016, and 62/382,451, filed Sep. 1, 2016, both entitled “Time Delay Device for Parachute Deployment,” both of which are hereby specifically and entirely incorporated by reference.

### BACKGROUND

### 1. Field of the Invention

This invention is directed to devices and methods for automatically opening a parachute. Specifically, the invention is also directed to devices and methods for delayed opening of a parachute during high altitude low opening deployment.

### 2. Description of the Background

High altitude low opening (“HALO”) parachuting is a method of deploying personnel, equipment, and supplies to the ground from aircraft flying at high altitudes. During a HALO drop, the person or package free-falls though the air for a period of time prior to the parachute opening. The parachute may be manually opened by a parachutist or automatically opened upon reaching a pre-determined altitude.

The origins of the HALO techniques date back to 1960 when the United States Air Force began conducting experiments on survivability for pilots ejecting at high altitude. As part of the experiments, on Aug. 16, 1960, Colonel Joseph Kittinger performed the first high-altitude jump at 19.5 miles (31.4 km) above the Earth's surface. The first time the technique was used for combat was during the Vietnam War in Laos. SEAL Team Six of the United States Navy expanded the HALO technique to include delivery of boats and other large items in conjunction with parachutists.

The technique is used to airdrop supplies, equipment, or personnel at high altitudes when aircraft can fly above surface-to-air missile (SAM) engagement levels through enemy skies without posing a threat to the transport or load. In the event that anti-aircraft cannons are active near the drop zone, the HALO technique also minimizes the parachutist's exposure to flak.

In a typical HALO exercise, the parachutist will jump from the aircraft, free-fall for a period of time at terminal velocity, and open their parachute at a low altitude. The combination of high downward speed, minimal forward airspeed, and the use of only small amounts of metal helps to defeat radar and reduces the amount of time a parachute might be visible to ground observers, enabling a stealthy insertion.

Deploying cargo via a HALO drop does not have the advantage of a person being able to determine when best to deploy the parachute. Instead, the parachute is typically deployed immediately upon the cargo exiting the aircraft. When deploying a parachute while flying at these higher altitudes and speeds several undesirable things may happen, including:

1) The parachute may be damaged due to the higher speed of the aircraft.

2) The accuracy of the cargo landing at or near the desired drop zone is greatly diminished.

3) The cargo is severely damaged due to excessive shock loading on the parachute harness.

In an effort to reduce or eliminate these issues, the cargo preferably will drop in a freefall fashion for a period of time until its forward speed has been reduced sufficiently thru air drag and load stabilization has occurred, thereby eliminating tumbling, before deploying the parachute system. Therefore, a need exits to reliably control the decent of the cargo and delay the deployment of the parachute.

### SUMMARY

The present invention overcomes the problems and disadvantages associated with current strategies and designs and provides new tools and methods for deploying parachutes.

One embodiment of the invention is directed to a delayed deployment device. The device comprises a housing containing a fluid, a piston adapted to move within the fluid contained in the housing, and an adjustable valve coupled to the piston accessible from outside the housing. The valve is adjusted to determine rate of motion of the piston through the housing.

In a preferred embodiment, the piston comprises a first end that is adapted to be coupled to a load and a second end that is adapted to be coupled to a release. Preferably, the piston is movable between a locked position and a released position. In the locked position, the release is preferably secured to the housing and in the released position, the release is preferably freed from the housing. Preferably, the second end of the piston engages a hole in the release in the locked position and disengages the hole in the release in the released position. In a preferred embodiment, in the released position, the release deploys a parachute. Preferably the second end of the piston is coupled to a drogue parachute. The drogue parachute preferably pulls the piston through the housing.

Another embodiment of the invention is directed to a parachute deployment system. The system comprises a load for deployment, a parachute coupled to the load, and a parachute deployment device coupled to the cargo and the parachute. The parachute deployment device comprises a housing containing a fluid, a piston adapted to move within the fluid contained in the housing, and an adjustable valve coupled to the piston accessible from outside the housing. The valve is adjusted to determine rate of motion of the piston through the housing and the timing of deployment of the parachute.

Preferably, the piston comprises a first end coupled to the cargo and a second end coupled to a release. The piston is preferably movable between a locked position and a released position. In a preferred embodiment, in the locked position, the release is secured to the housing and in the released position, the release is freed from the housing. Preferably, the second end of the piston engages a hole in the release in the locked position and disengages the hole in the release in the released position. In the released position, the release preferably deploys the parachute. Preferably, the second end of the piston is coupled to a drogue parachute. Preferably, the drogue parachute pulls the piston through the housing.

Another embodiment of the invention is directed toward a method of deploying cargo for high altitude, low opening (HALO) deployments. The method comprises the steps of coupling a parachute deployment device to the cargo, adjusting the valve to determine rate of motion of the piston through the housing and the timing of deployment of a stored parachute, coupling the stored parachute to the parachute deployment device, coupling a drogue parachute to the parachute deployment device, and deploying the cargo from a vehicle at high altitude. Upon deployment, the drogue parachute deploys and activates the parachute deployment system by pulling the piston through the housing until a release is freed from the parachute deployment system and the parachute is deployed. The parachute deployment device comprises a housing containing a fluid, a piston adapted to move within the fluid contained in the housing, and an adjustable valve coupled to the piston accessible from outside the housing.

Preferably, the piston is movable between a locked position and a released position. In a preferred embodiment, in the locked position, the release is secured to the housing and in the released position, the release is freed from the housing. Preferably, the second end of the piston engages a hole in the release in the locked position and disengages the hole in the release in the released position.

Other embodiments and advantages of the invention are set forth in part in the description, which follows, and in part, may be obvious from this description, or may be learned from the practice of the invention.

### DESCRIPTION OF THE FIGURES

FIGS. 1A-D depict views of an embodiment of a parachute deployment device.

FIG. 2 depicts an embodiment of a piston of the parachute deployment device.

FIG. 3 depicts an embodiment of a flow chart of a method of use of the parachute deployment device.

FIGS. 4A-B depict an embodiment of positions of the parachute deployment device during decent.

FIGS. 5A-E depict an embodiment of the system pre and post deployment of the parachute

FIG. 6 depicts another embodiment of a parachute deployment device.

### DESCRIPTION OF THE INVENTION

As embodied and broadly described herein, the present invention is directed to a device that utilizes a small drogue parachute attached to the cargo load and is deployed immediately as the individual cargo load exits the aircraft. The drogue chute activates the parachute deployment device, which deploys the parachute at a desired altitude.

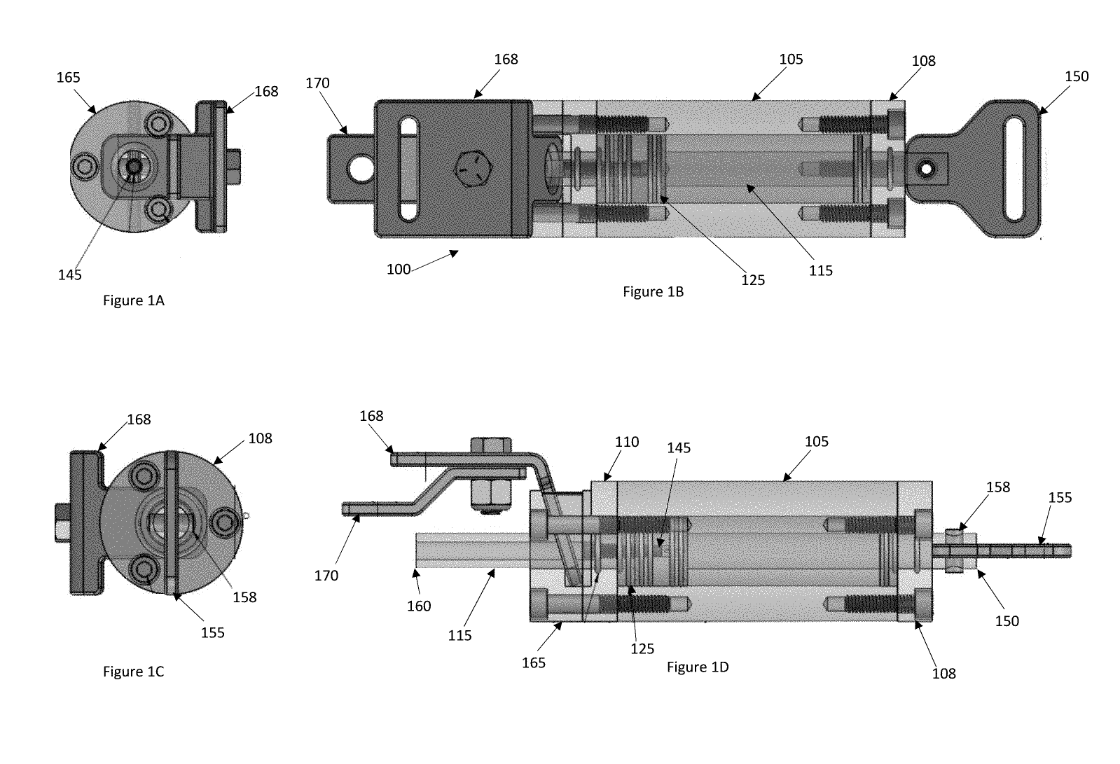

FIG. 1A depicts a top view of parachute deployment device 100. FIG. 1B depicts a side view of parachute deployment device 100. FIG. 1C depicts a bottom view of parachute deployment device 100. FIG. 1D depicts another side view of parachute deployment device 100. Preferably, parachute deployment device 100 is comprised of a tubular body 105. Although body 105 is shown as tubular, it can have another shape. Body 105 is preferably sealed at each end by endcaps 108 and 110. Endcaps 108 and 110 may be secured to body 105 by bolts (as shown), by adhesive, by welding, by friction, by threaded couplings, or another fastening device. In another embodiment, endcaps 108 and/or 110 are integral with body 105. Preferably once coupled to body 105, endcaps 108 and 110 provide an air tight and/or water tight seal. Preferably, body 105 and endcaps 108 and 110 are made of steel. However, other metals, plastics, ceramics, or other man made or naturally occurring materials can be used.

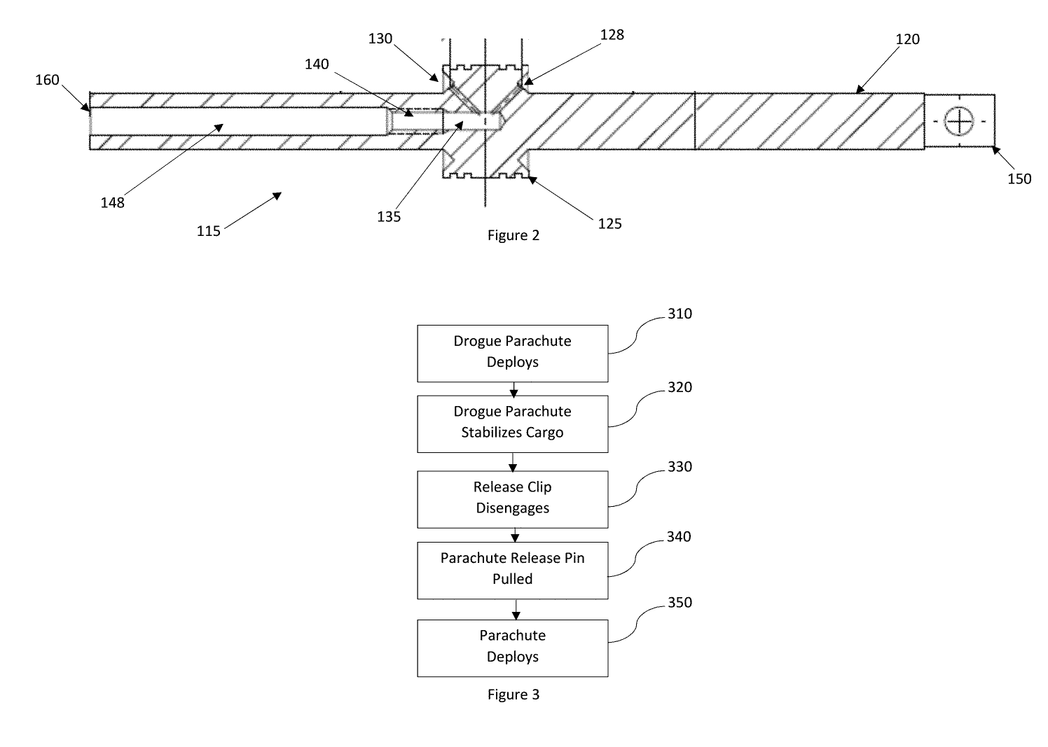

Preferably, within body 105 is piston 115. A cutaway side vie of piston 115 is shown in FIG. 2. Preferably, piston 115 is comprised of a rod 120 with a central cylinder block 125. Cylinder block 125 divides the interior of body 105 into two chambers. Preferably as piston 115 moves within body 105, one chamber increases in volume while the second chamber decreases in volume. Preferably, the change in volumes of the two chambers is at the same rate. The two chambers of body 105 are preferably filled with an incompressible fluid. For example, hydraulic fluid or mineral oil may be used. The fluid is preferably able to perform under both high and low temperatures. In a preferred embodiment, cylinder block 125 has one or more gaskets to prevent the fluid from leaking from one chamber to the other. Instead, cylinder block 125 preferably has a pair of conduits 128 and 130 that allow the fluid to pass from one chamber to the other. Preferably, each conduit 128 and 130 connects a chamber of body 105 with a cavity 135 within cylinder block 125. By varying the fluid, the size of conduits 128 and 130 and cavity 135, the rate at which piston 115 can move through body 105 can preferably be regulated. Preferably, the piston 115 moves though the fluid at a constant rate and the rate can be timed to correspond with the desired altitude of deployment of the parachute. By knowing the altitude of deployment, rate of decent of the cargo, and desired altitude of deployment of the parachute, the rate of motion of the piston 115 through the body 105 can be tuned to obtain the desired cargo drop characteristics. Preferably, to regulate the movement of piston 115 through body 105, valve 140 is positioned within rod 120. Preferably valve 140 is engageable by screw 145. Preferably, screw 145 is externally accessible. As screw 145 is tightened within valve 140, the volume of cavity 135 is reduced thereby limiting the rate of flow of fluid through cavity 135 and slowing the movement of piston 115. Preferably, screw 145 is accessible via a hollowed portion 148 of rod 120. The position of screw 145 may be set prior to assembly of parachute deployment device 100 or may be adjustable after assembly. While valve 140 is described as a screw valve, other types of valves or other devices to alter the volume of cavity 135 may be used. Preferably, once parachute deployment device 100 is assembled, valve 140 can be adjusted externally via screw 145 without opening or disassembling the device. Preferably, valve 140 can be adjusted without contaminating the fluid.

Upon assembly, a first end 150 of piston 115 passes through a hole in end cap 108 and is coupled to a load clip 155, for example, by dowel 158. Preferably, load clip 155 is adapted to be coupled to the load harness of the cargo or otherwise be attached to the cargo. The second end 160 of piston 115 passes through a hole in end cap 110. Preferably the holes in end caps 108 and 110 have gaskets or other seals to prevent the fluid from leaking out of body 105. Second end 160 preferably passes through end cover 165 and release clip 168 positioned within end cover 165. Release clip 168 is preferably coupled to a parachute harness and drogue clip 170. Drogue clip 170 is preferably coupled to a drogue parachute.

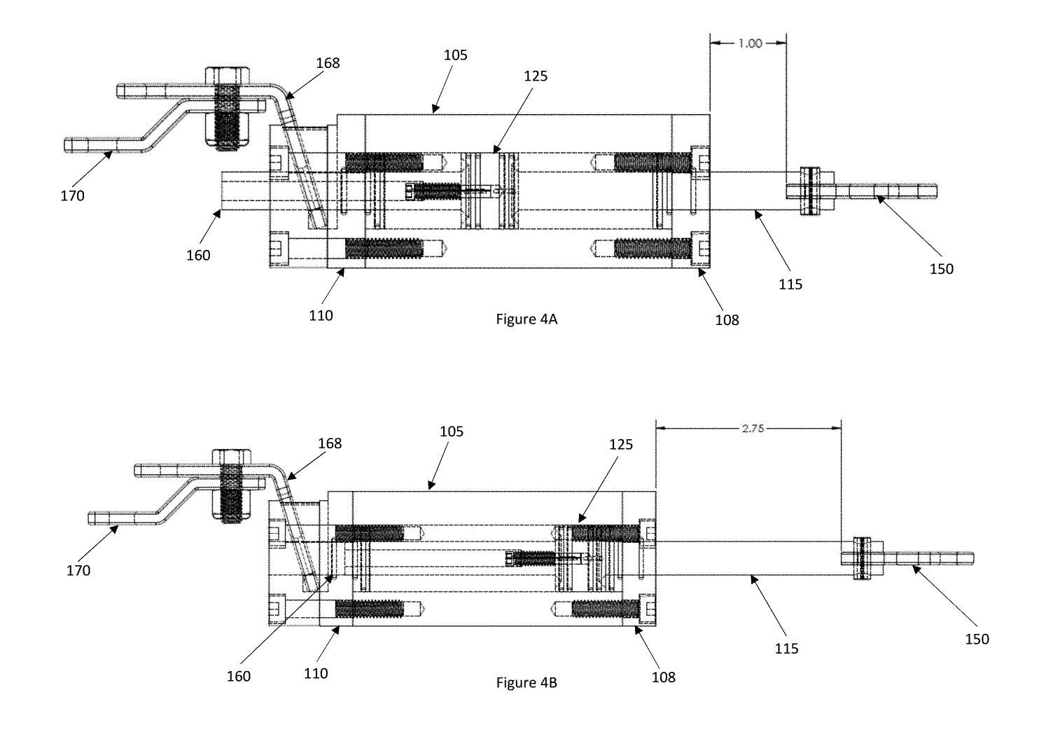

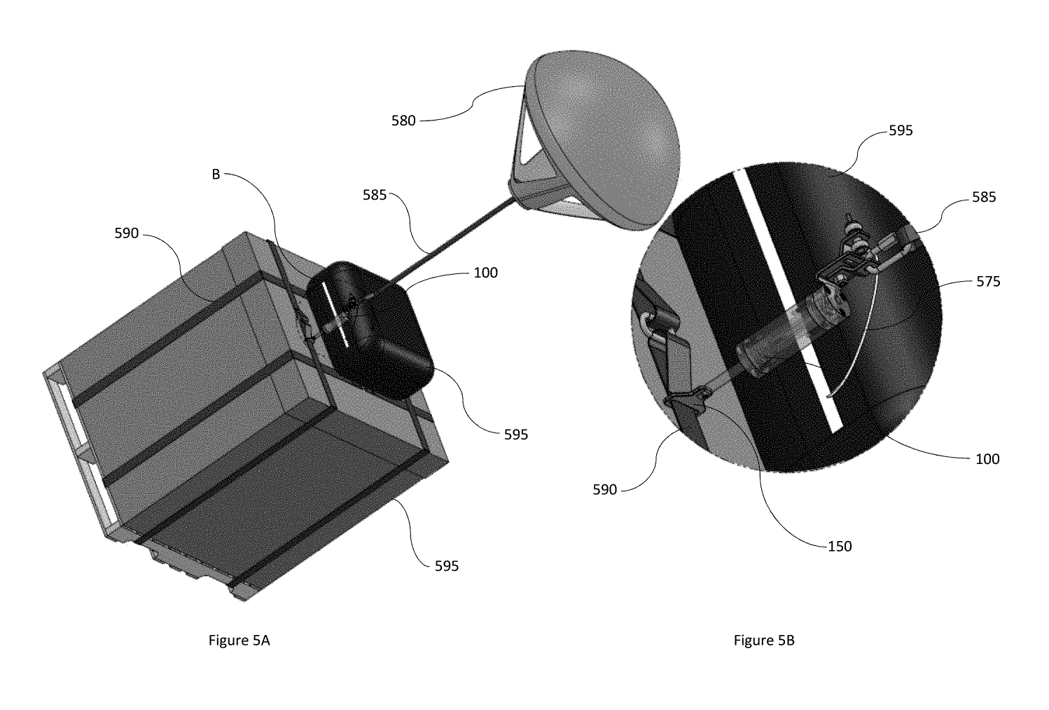

As shown in FIG. 3, upon deployment of the cargo from the aircraft, the drogue parachute deploys at step 310. FIGS. 4A-B depict the cargo 595 with the drogue parachute 580 deployed. Cargo 595 is coupled to load clip 155 of parachute deployment device 100 by strapping 590. Additionally, parachute containment device 595 is coupled to cargo 595. Drogue clip 170 of parachute deployment device 100 is coupled to drogue parachute 580 by tether 585. Release clip 168 of parachute deployment device 100 is preferably connected to harness strap 575, which when pulled deploys parachute 582.

Returning to FIG. 3, as the cargo free-falls through the air, the drogue parachute stabilizes the cargo and begins to pull on drogue clip 170 at step 320. The weight of the cargo is opposed by the drag of the drogue parachute thereby forcing piston 115 to move through body 105. For example, upon deployment, the position of piston 115 within body 105 is show in FIG. 1D. As can be seen in the figure, initially, cylinder block 125 is positioned adjacent to end cap 110 and load clip 150 is positioned adjacent to end cap 108. As the cargo continues to fall and the drogue parachute continues to resist the fall, piston 115 moves through body 105 to a middle position, as shown in FIG. 4A. Finally, preferably after a pre-determined amount of time, which corresponds to a pre-determined drop in altitude, piston 115 has moved fully through body 105, as shown in FIG. 4B. At the fully extended position, cylinder block 125 is positioned adjacent to end cap 108 and end 160 of piston 115, disengages release clip 168, and the drogue chute pulls on the slack harness strap 575 at step 330. The slack harness strap becomes taut and pulls the release pin of the parachute at step 340. At step 350, parachute 582 deploys and the cargo load preferably floats into the landing zone.

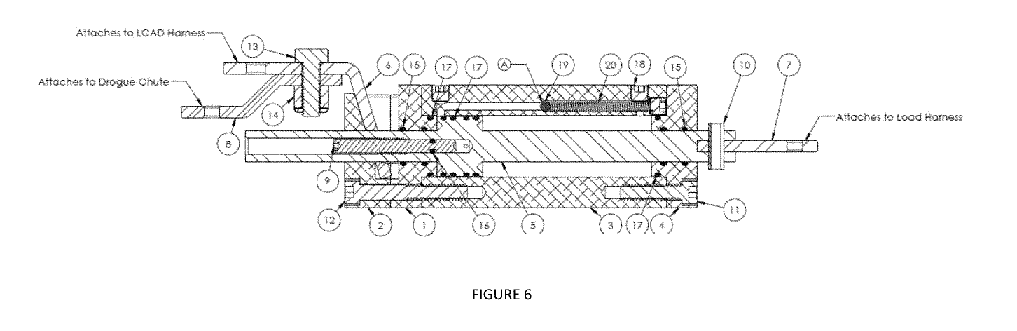

FIG. 6 depicts another embodiment of a parachute deployment device. The device of FIG. 6 is similar to the device shown in FIGS. 1A-1D with the inclusion of a release valve 19. The release valve 19 may be used to release the pressure within the device after deployment for resetting the device. Release valve 19 may be a ball check valve to assist in resetting the piston to the home position. This is preferably a time saving feature and can be utilized during assembly, fluid filling and testing operations. Valve 19 preferably reduces the force required when manually pushing the piston back to the starting position. It does this by allowing the hydraulic fluid to bypass traveling through the small piston orifice and instead travel through the port and check valve arrangement to get to the other side of the piston.

The parts shown in FIG. 6 include: End Cap A 1, End Cover 2, Cylinder Body 3, End Cap B 4, Actuating Piston 5, Release Clip 6, Load Clip 7, Drogue Clip 8, Set Screw 9, Spring Pin Dowel 10, Screws 11-13, Lock Nut 14, O-Rings 15-17, pipe plug 18, Valve 19, and Compression Spring 20. While a ball valve is shown in FIG. 6 other types of valve can be utilized.

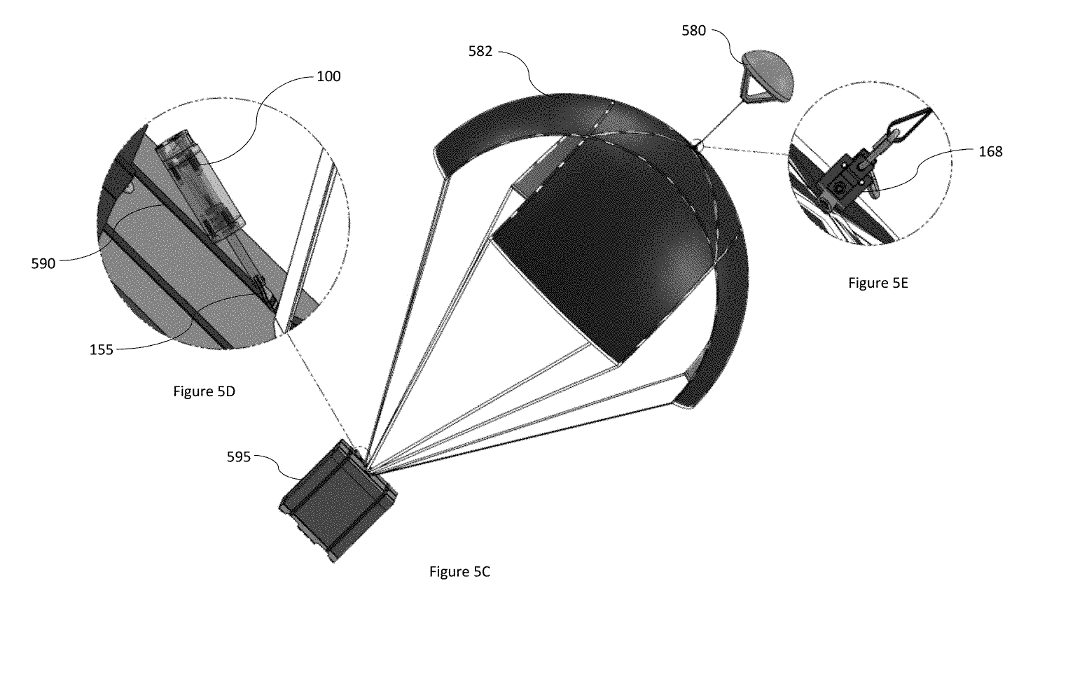

FIG. 5C-E depict the fully deployed parachute 582. When parachute 582 is deployed, drogue parachute 580 remains coupled to parachute 582 by release clip 168. Additionally, deployment device 100 remains coupled to cargo 595 by load clip 155 of parachute deployment device 100 coupled to strapping 590. In the preferred embodiment, parachute deployment device 100 is a one-time use device. However, in other embodiments, the parachuted deployment device 100 is reloadable and reusable.

Other embodiments and uses of the invention will be apparent to those skilled in the art from consideration of the specification and practice of the invention disclosed herein. All references cited herein, including all publications, U.S. and foreign patents and patent applications, are specifically and entirely incorporated by reference. The term comprising, where ever used, is intended to include the terms consisting and consisting essentially of. Furthermore, the terms comprising, including, and containing are not intended to be limiting. It is intended that the specification and examples be considered exemplary only with the true scope and spirit of the invention indicated by the following claims.

1. A delayed deployment device, comprising:
a housing containing a fluid;
a piston adapted to move within the fluid contained in the housing; and
an adjustable valve coupled to the piston accessible from outside the housing;
wherein the valve is adjusted to determine rate of motion of the piston through the housing.

2. The delayed deployment device of claim 1, wherein the piston comprises a first end that is adapted to be coupled to a load and a second end that is adapted to be coupled to a release.

3. The delayed deployment device of claim 2, wherein the piston is movable between a locked position and a released position.

4. The delayed deployment device of claim 3, wherein in the locked position, the release is secured to the housing and in the released position, the release is freed from the housing.

5. The delayed deployment device of claim 4, wherein the second end of the piston engages a hole in the release in the locked position and disengages the hole in the release in the released position.

6. The delayed deployment device of claim 4, wherein in the released position, the release deploys a parachute.

7. The delayed deployment device of claim 2, wherein the second end of the piston is coupled to a drogue parachute.

8. The delayed deployment device of claim 7, wherein the drogue parachute pulls the piston through the housing.

9. A parachute deployment system, comprising:
a load for deployment;
a parachute coupled to the load; and
a parachute deployment device coupled to the cargo and the parachute, the parachute deployment device comprising:
a housing containing a fluid;
a piston adapted to move within the fluid contained in the housing; and
an adjustable valve coupled to the piston accessible from outside the housing;
wherein the valve is adjusted to determine rate of motion of the piston through the housing and the timing of deployment of the parachute.

10. The parachute deployment system of claim 9, wherein the piston comprises a first end coupled to the cargo and a second end coupled to a release.

11. The parachute deployment system of claim 10, wherein the piston is movable between a locked position and a released position.

12. The parachute deployment system of claim 11, wherein in the locked position, the release is secured to the housing and in the released position, the release is freed from the housing.

13. The parachute deployment system of claim 12, wherein the second end of the piston engages a hole in the release in the locked position and disengages the hole in the release in the released position.

14. The parachute deployment system of claim 12, wherein in the released position, the release deploys the parachute.

15. The parachute deployment system of claim 9, wherein the second end of the piston is coupled to a drogue parachute.

16. The parachute deployment system of claim 15, wherein the drogue parachute pulls the piston through the housing.

17. A method of deploying cargo for high altitude, low opening (HALO) deployments, comprising:
coupling a parachute deployment device to the cargo, the parachute deployment device comprising:
a housing containing a fluid;
a piston adapted to move within the fluid contained in the housing; and
an adjustable valve coupled to the piston accessible from outside the housing;
adjusting the valve to determine rate of motion of the piston through the housing and the timing of deployment of a stored parachute;
coupling the stored parachute to the parachute deployment device;
coupling a drogue parachute to the parachute deployment device; and
deploying the cargo from a vehicle at altitude;
wherein, upon deployment, the drogue parachute deploys and activates the parachute deployment system by pulling the piston through the housing until a release is freed from the parachute deployment system and the parachute is deployed.

18. The method of claim 17, wherein the piston is movable between a locked position and a released position.

19. The method of claim 18, wherein in the locked position, the release is secured to the housing and in the released position, the release is freed from the housing.

20. The method of claim 19, wherein the second end of the piston engages a hole in the release in the locked position and disengages the hole in the release in the released position.
